(19) United States
(12) Patent Application Publication
(10) Pub. No.: US 2003/0129030 A1
(43) Pub. Date: Jul. 10, 2003

(54) Lubricant sheet and method of forming the same

(75) Inventor: Robert M. Johnston, Bellingham, VA (US)

Correspondence Address: MARK KUSNER COMPANY LPA, HIGHLAND PLACE SUITE 310, 6151 WILSON MILLS ROAD, HIGHLAND HEIGHTS, OH, 44143

(73) Assignee: JJA, Inc.

(21) Appl. No.: 10/038,238

(22) Filed: Jan. 4, 2002

(51) Int. Cl. C 10M 1 7/34; B23B 35/00

(52) U.S. Cl. 408/1 R; 508/100

(57) ABSTRACT

A lubricant sheet for use in drilling holes in a printed circuit board, comprised of a porous, fibrous, organic sheet impregnated with a water-soluble lubricant. The lubricant is comprised essentially of polyethylene glycol having a weight average molecular weight between 4,500 and 7,000, and a surfactant.

### FIELD OF THE INVENTION

The present invention relates generally to the art of drilling holes in printed circuit board panels, and more particularly to a lubricant sheet for use in drilling such holes to reduce or eliminate dielectric smear and drill tool wear.

### BACKGROUND OF THE INVENTION

It has been known to use lubricant sheets when drilling through-holes in printed circuit board panels. U.S. Pat. No. 4,781,495 and U.S. Pat. No. 4,929,370, both to Hatch et al., disclose the use of a lubricant sheet for drilling through-holes in printed circuit board panels. These patents disclose impregnating a porous sheet of paper with a mixture containing a solid water-soluble lubricant of a glycol, a fatty acid ester and a non-ionic surfactant.

U.S. Pat. No. 5,082,402 to Gaku et al. purports to provide an improved method of drilling through-holes in printed circuit board panels to overcome perceived deficiencies of stickiness and workability of the lubricant sheet disclosed in the aforementioned patents. The Gaku et al. patent discloses a method of drilling through-holes in printed circuit board panels utilizing a water-soluble lubricant sheet comprised of a mixture of 20-90 percent by weight polyethylene glycol having an average molecular weight of over 10,000.

The present invention is an improvement to the lubricant sheets and drilling processes heretofore described, and provides a lubricant sheet comprised essentially of polyethylene glycol having a weight average molecular weight of between 4,500 and 7,000, and a surfactant.

### SUMMARY OF THE INVENTION

In accordance with the present invention, there is provided a lubricant sheet for use in drilling holes in a printed circuit board comprised of a porous, fibrous sheet impregnated with a water-soluble lubricant and a surfactant. The lubricant is comprised essentially of polyethylene glycol having a weight average molecular weight of between 4,500 and 7,000, and a melting temperature not less than 120° F.

It is an object of the present invention to provide a lubricant sheet for use in drilling holes in printed circuit boards.

Another object of the present invention is to provide a lubricant sheet as described above that is comprised of a porous, fibrous sheet impregnated with a lubricant.

Another object of the present invention is to provide a lubricant sheet as described above, wherein the lubricant is comprised essentially of polyethylene glycol.

Another object of the present invention is to provide a lubricant sheet as described above, wherein the lubricant includes a surfactant.

Another object of the present invention is to provide a lubricant sheet as described above that does not require a metallic backing for support.

A still further object of the present invention is to provide a lubricant sheet as described above that contains no biologically or environmentally harmful materials.

These and other objects will become apparent from the following description of a preferred embodiment taken together with the accompanying drawings and the appended claims.

### BRIEF DESCRIPTION OF THE DRAWINGS

The invention may take physical form in certain parts and arrangement of parts, a preferred embodiment of which will be described in detail in the specification and illustrated in the accompanying drawings which form a part hereof, and wherein:

FIG. 1 is a schematic view of an apparatus for forming a lubricant sheet for use in drilling holes in printed circuit boards in accordance with the present invention;

FIG. 2 is an enlarged view of a portion of the apparatus shown in FIG. 1;

FIG. 3 is an enlarged, sectional view taken along lines 3-3 of FIG. 1, showing a fibrous sheet used in forming a lubricant sheet in accordance with the present invention;

FIG. 4 is an enlarged, sectional view taken along lines 4-4 of FIG. 2, showing the fibrous sheet of FIG. 3 after it has been coated with a water-soluble lubricant;

FIG. 5 is an enlarged, sectional view taken along lines 5-5 of FIG. 2, showing a lubricant-impregnated sheet as shown in FIG. 4 after shaping into a desired thickness; and

FIG. 6 is an enlarged, sectional view taken along lines 6-6 of FIG. 1, showing a lubricant sheet after the lubricant has hardened.

### DETAILED DESCRIPTION OF PREFERRED EMBODIMENT

The present invention relates to a lubricant sheet 10, schematically illustrated in FIG. 6, for use in drilling holes in printed circuit board panels. Lubricant sheet 10 is basically comprised of a porous, organic sheet 12 impregnated with a water-soluble lubricant 14 that is essentially a solid at room temperature.

Sheet 12 functions essentially as a carrier for lubricant 14. Therefore, any porous, organic material would find advantageous application in forming sheet 12. In this respect, sheet 12 may be formed of woven or non-woven fabric formed from natural materials such as cotton or wool, but in accordance with the present invention, it is preferably formed of a porous, water-dissolvable paper sheet, wherein water-soluble lubricant 14 is absorbed into the pores and recesses of sheet 12, as well as coating the exterior surfaces of sheet 12 as a thin film, designated 16 in the drawings.

Lubricant 14 is comprised essentially of polyethylene glycol and a surfactant. The polyethylene glycol has a weight average molecular weight that falls within a range of 4,500 to 7,000. More preferably, the weight average molecular weight of lubricant 14 is between 5,500 and 6,500, and the melting temperature is above 125° F. (about 52° C.). At weight average molecular weights below 4,500, polyethylene glycol is generally sticky and tacky wherein adjacent sheets of lubricant sheet 10, if arranged in a stack, are susceptible to sticking together and/or conglomerating into a single mass. At weight average molecular weights above 7,000, polyethylene glycol is relatively hard and brittle, and a lubricant sheet 10, if formed of such material, is susceptible to cracking or flaking. Between 4,500 and 7,000 weight average molecular weight, and more particularly between 5,500 and 6,500 weight average molecular weight, the polyethylene glycol on lubricant sheet 10 is flexible but not sticky or tacky.

Lubricant 14 preferably has a melting temperature above 120° F. (about 49° C.). At weight average molecular weights between 4,500 and 7,000, polyethylene glycol has a melting point between 134° F. (about 57° C.) and 144° F. (about 62° C.). With a melting temperature within such a range, lubricant sheets may be stacked and shipped without a separator sheet or layer between adjacent lubricant sheets 10.

Polyethylene glycol is commercially available in various weight average molecular weights. In this respect, to obtain a polyethylene glycol having a desired weight average molecular weight, it may be necessary or desirable to blend two or more components of polyethylene glycol of different weight average molecular weights. This can be accomplished by melting different weight average molecular weight polyethylene glycols and mixing them together to obtain a desired weight average molecular weight and desired melting temperature.

Referring now to the surfactant component of lubricant 14, a variety of different surfactants may be used. The surfactant is added to promote better welting and flow of the polyethylene glycol(s) in use. The amount of surfactant added to the polyethylene glycol may vary depending on the molecular weight of the polyethylene glycol and on the type of surfactant used. Preferably, the minimum amount of surfactant necessary to promote good wetting and flow of the polyethylene glycol is used. Preferably less than 5% of lubricant 14 is surfactant. In a preferred embodiment, a surfactant sold under the tradename TERGITOL is used.

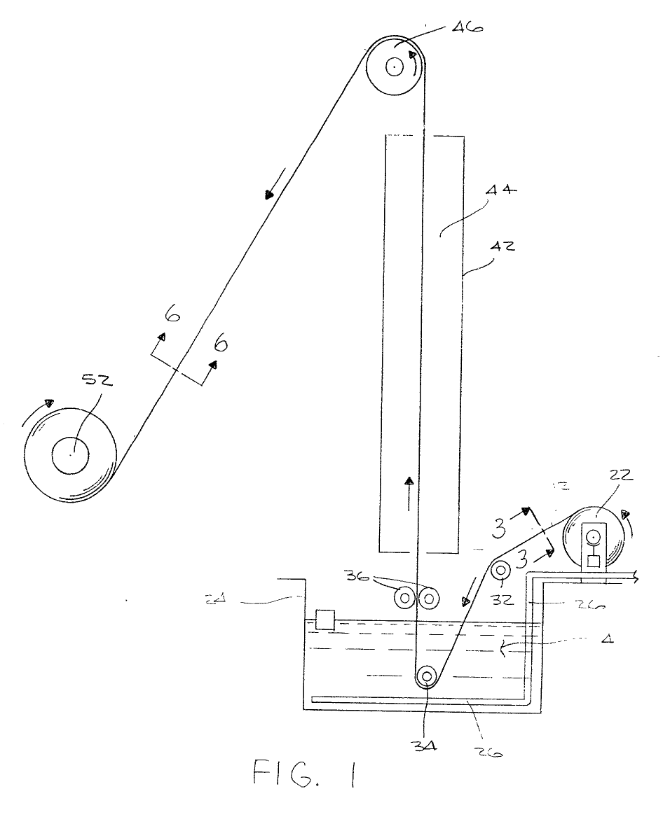

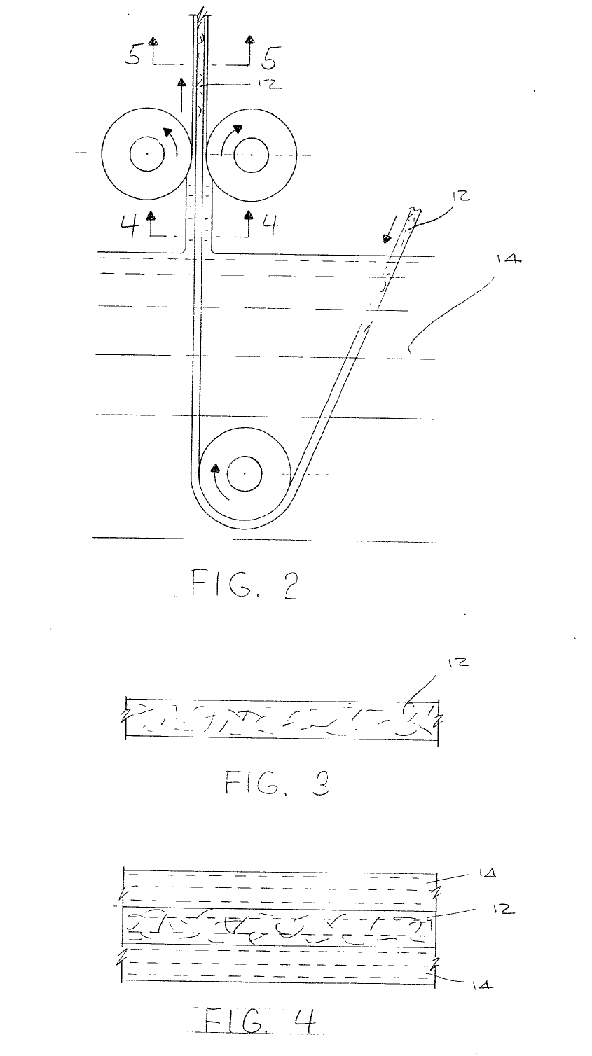

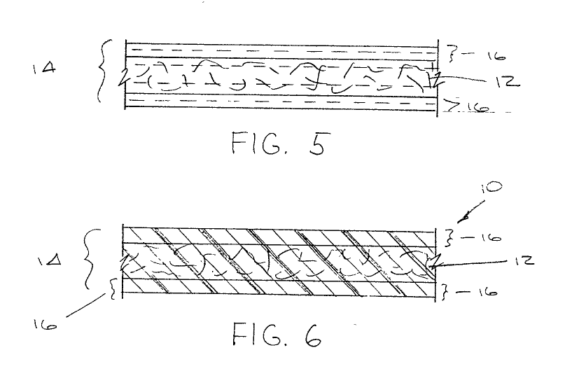

Referring now to the drawings wherein the showings are for the purpose of illustrating one technique for making lubricant sheet 10, FIG. 1 schematically illustrates a manufacturing line for forming a lubricant sheet 10. A roll 22 of sheet material 12 is disposed adjacent a tank 24. Tank 24 contains a bath of lubricant 14, i.e., polyethylene glycol(s). A heating element 26 is provided to heat and melt the polyethylene glycol(s) within tank 24. Sheet 12 from roll 22 is directed into and through tank 24 by guide rollers 32, 34. FIG. 3 is cross-sectional view of sheet 12 prior to entry into tank 24. FIG. 4 is a cross-sectional view of sheet 12 after it has been impregnated with lubricant 14 from tank 24. Sheet 12 with lubricant sheet 14 thereon is then conveyed between forming or shaping rollers 36. In this respect, shaping rollers 36 define the thickness of lubricant sheet 10 and remove excess lubricant 14 from sheet 12. A thin layer of film 16 of lubricant 14 remains on each side of sheet 12, as best seen in FIG. 5.

Sheet 12, with lubricant 14 thereon, is then conveyed through a cooling device 42 having a cooling chamber 44 therein. Sheet 12, with lubricant 14 thereon, passes through cooling chamber 44, wherein the polyethylene glycol is cooled to a temperature below its melting point wherein it will solidify upon sheet 12, as schematically illustrated in FIG. 6. From cooling chamber tower 44, lubricant sheet 10 is directed over a guide roller 46 onto a take-up roller 52. Lubricant sheet 10 preferably has a thickness between 4 mils and 6 mils, wherein film layer 16 has a thickness of about 2 mils. Lubricant sheet 10 may be provided to users in roll form, or may be cut into sheets (not shown) and stacked for shipment as a packet of lubricant sheets 10.

Referring now to the operation of lubricant sheet 10, in a conventional process of drilling through-holes in printed circuit board panels, a plurality of individual panels (not shown) are stacked one above another. An entry sheet is typically provided above the stack and an exit sheet of material is disposed at the bottom of the stack. The entry and exit materials are typically sheets of a paper-based material or thin metal sheets, such as aluminum. The printed circuit board panels are clad with copper on both sides and have an intermediate insulating layer, such as an epoxy-glass resin between the conductive metal layers.

High-speed drills are used to drill holes through the stack of panels and entry sheet and exit sheet materials. In accordance with the present invention, lubricant sheet 10 is provided to a user in either roll or sheet form. A layer of lubricant sheet 10 is preferably placed between each panel to be drilled. Additional layers of lubricant sheets may also be placed between the entry sheet and its adjacent panel and the exit sheet and its adjacent panel.

Lubricant sheet 10 provides cooling and lubrication to the drill during a drilling operation. In this respect, the polyethylene glycol and surfactant lubricant 14 melts when contacted by a hot drill bit. The surfactant facilitates good wetting and thus, good flow of lubricant onto and around the drill bit. In one respect, polyethylene glycol is a very good lubricant for cutting tools, and the drill becomes coated with polyethylene glycol, thereby providing a lubricant to the drill bit. In another respect, polyethylene glycol has a very high, specific heat and can absorb a great deal of heat as it melts. The polyethylene glycol cools the drill bit and the panel stack. As noted above, in accordance with the present invention, lubricant 14, i.e., polyethylene glycol and surfactant, has a relatively low melting temperature that falls between about 134° F. and about 144° F. As a result, in addition to lubricating the drill, the melting of the polyethylene glycol on lubricant sheet 10 cools the drill bit. As a result of the lubricating and cooling effects, wear on critical areas of the drill is reduced, as is the smearing in the drill hole. The polyethylene glycol lubricant reduces the friction of the rotating drill bit as well as the friction of the departing chip removed by the drill bit.

The invention shall now be described by way of Example.

### EXAMPLE I

A lubricant sheet 10 is formed using a porous, paper sheet impregnated with a mixture of two components of polyethylene glycol. The paper sheet is a fibrous tissue paper, manufactured by Seaman Paper Company of Otter River, Miss., under the designation: Satan Wrap, 101b number 1 white, 87 GE brightness, neutral pH. The paper has a thickness of about 1 mil.

To obtain a desired lubricant mixture from commercially available polyethylene glycol formulas, the following polyethylene glycol components, available from Union Carbide under the trademark CARBOWAX®, are blended.

| | | Range of | Melting or | |
|---|---|---|---|---|
| | | Average | Freezing | Heat of |
| Material | | Molecular | Range, | Fusion, |
| (Polyethylene Glycol) | Amount | Weight | ° C. | cal/g |
| CARBOWAX ® 8000 | 100 | 7,000 to 9,000 | 60 to 63 | 41 |
| | parts | | | |
| CARBOWAX ® 300 | 22 | 285 to 315 | −15 to −8 | 37 |
| | parts | | | |

6 parts of TERGITOL surfactant are added to the polyethylene glycol.

The paper sheet is impregnated with the mixture of the foregoing polyethylene glycol components and is formed into a lubricant sheet 10 having a thickness of about 5 mils, wherein film layer 16 has a thickness of about 2 mils.

### EXAMPLE II

A lubricant sheet 10 is formed using a porous, paper sheet impregnated with a mixture of three components of polyethylene glycol. The paper sheet is a fibrous tissue paper, manufactured by Seaman Paper Company of Otter River, Miss., under the designation: Satan Wrap, 101b number 1 white, 87 GE brightness, neutral pH. The paper has a thickness of about 1 mil.

To obtain a desired lubricant mixture from commercially available polyethylene glycol formulas, the following polyethylene glycol components, available from Union Carbide under the trademark CARBOWAX®, are blended.

| | | Range of | Melting or | |
|---|---|---|---|---|
| | | Average | Freezing | Heat of |
| Material | | Molecular | Range, | Fusion, |
| (Polyethylene Glycol) | Amount | Weight | ° C. | cal/g |
| CARBOWAX ® 8000 | 100 | 7,000 to 9,000 | 60 to 63 | 41 |
| | parts | | | |
| CARBOWAX ® 1000 | 10 | 950 to 1,050 | 37 to 40 | 38 |
| | parts | | | |
| CARBOWAX ® 300 | 15 | 285 to 315 | −15 to −8 | 37 |
| | parts | | | |

6 parts of TERGITOL surfactant are added to the polyethylene glycol.

The paper sheet is impregnated with the mixture of the foregoing polyethylene glycol components and is formed into a lubricant sheet 10 having a thickness of about 5 mils, wherein film layer 16 has a thickness of about 2 mils.

The present invention thus provides a lubricant sheet for drilling through-holes in printed circuit board panels that provides a cooling and lubricating effect to prolong the life of drill bits and produce smoother through-holes with reduced smearing and nail-heading.

The foregoing description is a specific embodiment of the present invention. It should be appreciated that this embodiment is described for purposes of illustration only, and that numerous alterations and modifications may be practiced by those skilled in the art without departing from the spirit and scope of the invention. In this respect, although examples of the present invention disclose the use of fibrous tissue paper, other types of porous paper made from fibrous materials may find advantageous application in the present invention. It is intended that all such modifications and alterations be included insofar as they come within the scope of the invention as claimed or the equivalents thereof.

Having described the invention, the following is claimed:

1. A lubricant sheet for use in drilling holes in a printed circuit board, comprised of: a porous, fibrous, organic sheet impregnated with a water-soluble lubricant, said lubricant comprised essentially of polyethylene glycol having a weight average molecular weight between 4,500 and 7,000, and a melting temperature greater than 120° F.

2. A lubricant sheet as defined in claim 1, wherein said porous, fibrous sheet is paper.

3. A lubricant sheet as defined in claim 2, wherein said paper is a fibrous tissue paper.

4. A lubricant sheet as defined in claim 1, wherein said organic sheet is a cloth.

5. A lubricant sheet as defined in claim 4, wherein said cloth is woven.

6. A lubricant sheet as defined in claim 4, wherein said cloth is formed from a material selected from the group consisting of wool, cotton, nylon and blends thereof.

7. A lubricant sheet as defined in claim 1, wherein said lubricant is a mixture of at least two polyethylene glycol's each having a different weight average molecular weight.

8. A lubricant sheet as defined in claim 7, wherein said lubricant is a mixture, comprised of:
between 90 and 110 parts of first polyethylene glycol having a weight average molecular weight between 7,000 and 9,000; and
between 15 and 25 parts of a second polyethylene glycol having a weight average molecular weight between 285 and 315.

9. A lubricant sheet as defined in claim 7, wherein said lubricant is a mixture comprised of:
between 90 and 110 parts of a first polyethylene glycol having a weight average molecular weight between 7,000 and 9,000;
between 7 and 15 parts of a second polyethylene glycol having a weight average molecular weight between 950 and 1,050; and
between 10 and 20 parts of a third polyethylene glycol having a weight average molecular weight between 285 and 315.

10. A lubricant sheet as defined in claim 1, wherein said lubricant sheet has a thickness of between 4 mils and 6 mils.

11. A lubricant sheet as defined in claim 1, further comprising a surfactant.

12. A lubricant sheet as defined in claim 11, wherein said surfactant comprises between 3 parts and 8 parts of said lubricant.
